(19) United States
(12) Patent Application Publication
(10) Pub. No.: US 2009/0208317 A1
(43) Pub. Date: Aug. 20, 2009

(54) Grapple apparatus for a three point hitch

(76) Inventor: Sidney Kylie Burch, Columbia, MS (US)

Correspondence Address: MORRIS & ASSOCIATES, P.O. BOX 1993, 15312 RYAN AVENUE, PRAIRIEVILLE, LA, 70769, US

(21) Appl. No.: 11/013,850

(22) Filed: Dec. 16, 2004

(51) Int. Cl. B66C 1/28

(52) U.S. Cl. 414/739

(57) ABSTRACT

An apparatus for attachment to a farm tractor or other vehicle having a three point hitch system. The apparatus provides a grapple on a rotational platform which enables the lifting of material, such as logs, trees or the like. The grapple arms are configured to grapple varying sizes of material. The apparatus uses a connecting member which provides rigid structure to prevent downward rotation of the grapple when in a loading state and flexible structure to allow downward or upward rotation of the grapple said second frame about said first frame when grapple means is in a resting state. Various configuration of the grapple arm enables handling different size materials.

### BACKGROUND OF THE INVENTION

The present invention concerns equipment for dragging logs over terrain. Commonly such is accomplished in large scale operations by the use of a vehicle termed a skidder which is wheel or track equipped with a grapple for log engagement. Such vehicles are suited primarily for the single task noted and are equipped with complex hydraulic systems for vehicle drive and grapple operation making their use practical only in full time, high volume logging operations.

Also, small scale logging efforts are common. For example, owners of small tracts of timber are often primarily farmers with farm tractors or trucks of the type including a three point hitch for the attachment of various farm implements. Such vehicles are not favorably usable for the skidding of logs to a collection or loading site which requires that the forward end of the log be elevated somewhat to avoid hanging up on ground obstacles.

The larger log skidders have grapple positioning mechanisms which require costly hydraulic components including pumps, valves, cylinders, etc., not suitable for farm tractor installation. Such apparatus also are often oversized for use with a standard farm tractor, even if equipped with a three point hitch system.

A further desirable feature is holding dependability; that is to say, the grapple closing force should be adequate to prevent logs from vertically falling out of the grapple jaws. While the grapple closing force may be adequate to prevent logs from vertically falling out of the grapple jaws, the holding characteristics of the jaws may not be such as to prevent the logs slipping out longitudinally, particularly in the skidding operation where the logs rest on and are dragged along the ground. Holding dependability in conventional logging grapples depends heavily upon large spikes or teeth on the inner surfaces of the jaws. However such spikes and teeth have been known to cause undesirable log damage and, in any case, do not provide the holding effectiveness of conventional choker cables which bite into a log or logs to an extent which is in direct proportion to the weight thereof Yet, the use of choker cables required additional handling and safety concerns, particularly for the small farmer.

It is one object of this invention to provide an improved grapple assembly, especially designed for log skidding, of compact and light construction, wherein the cable which closes the grapple also spans the opening of the grapple jaws and bears upon and bites into a log or logs between jaws.

It is a further object of this invention to provide a jaw closing force substantially equal to or greater than the force required to resist the force of gravity on the grappled load, irrespective of the size of the load or the working position of the grapple jaws relative to one another.

Yet another object of this invention is to provide a grapple closing mechanism such that the opening members may be either rigid or flexible, of simple construction, and wherein the closing force between the jaws does not depend upon compressive forces in the opening members.

Still another object of the invention is to provide a grapple closing mechanism which applies a closing force to the jaws below the jaw pivot pin and directly across the jaw opening.

It is still another object of this invention to provide an embodiment thereof wherein the opening members are interconnected to a manipulating boom which provides at least one degree of freedom of either angular or linear motion to the grapple.

It is another object of this invention to provide an embodiment thereof wherein the opening members are flexible and interconnected with actuating means such that the grapple jaws may be raised or lowered either jointly or severally with respect to the boom, wherein those flexible opening members may be used in combination with a grapple closing cable to locate the grapple over a turn of logs, and wherein those flexible opening members may be slackened when the grapple and a turn of logs are drawn up firmly against the skidder by the closing cable.

Yet a further object of this invention is to provide an embodiment thereof wherein a closing cable first fair-lead means mounted in the boom is adapted to interact with a closing cable second fairlead means mounted on the grapple such that when the opening members are slack or disconnected, and the grapple is drawn up firmly against the boom by the closing cable, the grapple is substantially free to swing universally with respect to the boom.

The present invention is adapted for use with log skidders and is directed toward combining the operating versatility and labor saving characteristics of log grapples with the holding dependability of log chokers.

These and still further objects and advantages of the present invention reside in the details of construction of a preferred embodiment disclosed herein and will be evident to one skilled in the art from a study of the specification and the accompanying drawings. Therefore the preferred embodiment disclosed is merely exemplary and is not intended to detract from the full scope of the invention as set out in the annexed claims.

### SUMMARY OF THE PRESENT INVENTION

The present invention is directed toward the provision of a log transporting attachment for farm tractors of the type having a three point hitch. More particularly, it is an apparatus for attachment to a farm tractor or other vehicle having a three point hitch system. The apparatus provides a grapple on a rotational platform which enables the lifting of material, such as logs, trees or the like. The grapple arms are configured to grapple varying sizes of material. The apparatus uses a connecting member which provides rigid structure to prevent downward rotation of the grapple when in a loading state and flexible structure to allow downward or upward rotation of the grapple said second frame about said first frame when grapple means is in a resting state. Various configuration of the grapple arm enables handling different size materials.

Important objectives include the provision of a log moving apparatus for use with a three point hitch equipped tractor and having a grapple assembly positioned by a resilient component without reliance on a hydraulic component; the provision of a log moving apparatus suitable for use on most medium sized or larger farm tractors to enable farmers to accomplish small scale logging efforts without use of costly log skidding equipment or contracting for the services of professional loggers which may render such logging efforts economically impractical; the provision of a log moving attachment which is readily coupled to a medium size or larger farm tractor using the tractor three point hitch and the tractor hydraulic components for positioning a log lifting frame of the apparatus

### BRIEF DESCRIPTION OF THE DRAWINGS

FIG. 1 is a side elevation view of a tractor with the present implement attached thereon at the tractor's well-known three point hitch.

FIGS. 2a and 2b are respectively top and side elevation views of the implement which is attached to the tractor's three points of FIG. 1, taken from the right side of FIG. 1.

### DETAILED DESCRIPTION OF THE PREFERRED EMBODIMENTS

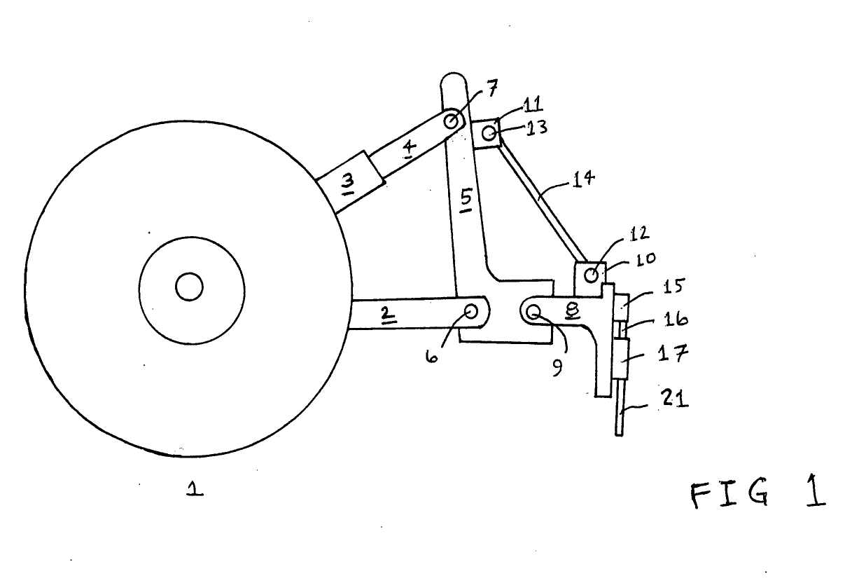

With continuing attention to the drawings wherein applied reference numerals indicate parts similarly hereinafter identified, in FIG. 1 the reference numeral 1 identifies a wheel and rear axel assembly of a tractor of the type termed a farm tractor by reason of widespread acceptance for agricultural purposes.

The tractor having wheel and rear axel assembly 1 includes a pair of rearwardly trailing arms 2 and a hydraulic cylinder 3 with the hydraulic cylinder arm 4 powered and adjustable normally for attachment to various implements. Arms 2 and 4 are attached to an implement mounting frame 5 with pins 6 and 7 respectively. In view of such hitches being in wide use further description is believed unnecessary.

With attention now to the present attachment, the same includes side plates 8 pinned to mounting frame 5 with pins 9 and welded to base plate 15. Mounting bracket 10 is welded to the bottom of base plate 15 and includes a pin 12. Mounting bracket 11 is welded to mounting frame 5 and includes pin 13. Pins 12 and 13 secure chain 14 (which can be a wire alternatively) respectively to mounting brackets 10 and 11.

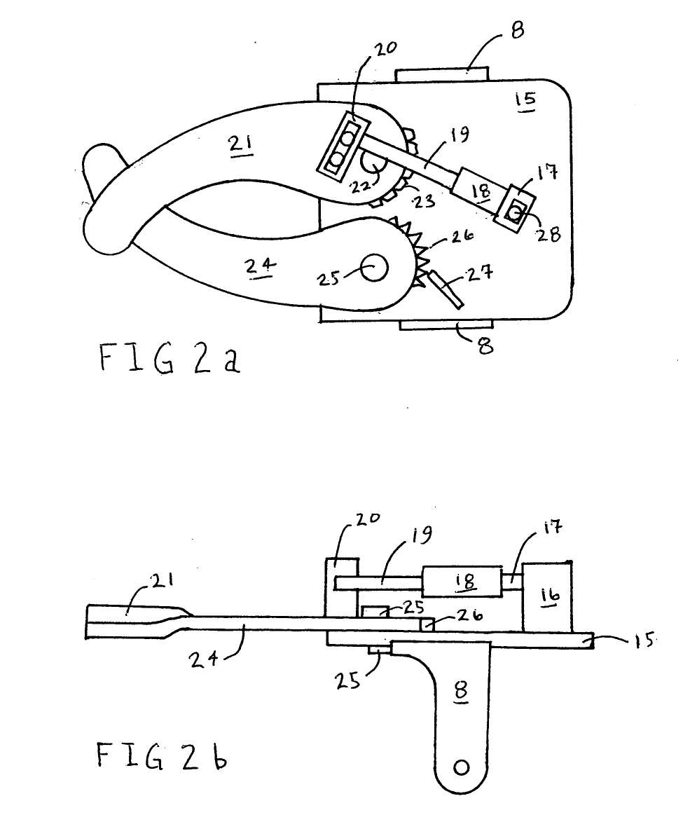

On base plate 15 there is housing 16 (shown in FIG. 2b, but not FIG. 2a), which protects metal post 28, which is surrounded by translation frame 17, which is affixed to hydraulic cylinder 18 in a manner which permits the cylinder to translationally and rotationally move about post 28. Hydraulic fluid is injected or withdrawn from hydraulic cylinder 18 through hydraulic lines not depicted in the drawing to provide the force to move hydraulic arm 19. Hydraulic arm 19 is translationally positioned at one end within cylinder 18 and rotatably pinned within housing 20 mounted on master grapple arm 21. Master grapple arm 21 is rotatably pinned to base plate 15 with pin 22. Servant arm 24 is rotatably pinned to base plate 15 with pin 25. Master grapple arm 21 and servant grapple arm 24 respectively include gear teeth 23 and 26. Gear teeth 23 and 26 interlock and act such that when master grapple arm 21 is rotated through force from hydraulic cylinder 18, servant grapple arm 24 is rotated through force from master grapple arm 21. Stop 27 prevents the servant (and resultingly, the master) grapple arms from rotating too far for recovery.

Activation of three point hitch components 3 and 4 will result in elevating frame member 5 by rotation about pin 6. Activation may either lower or raise the implement rotatably attached at pin 9. Since chain 14 is not a rigid structure, when the frame 5 is rotated to lower the grapple arms into contact with the ground, force from the hydraulic cylinder is not involved because the chain flexes. Accordingly, driving the grapple arms into the ground is avoided.

Master grapple arm 21 and servant grapple arm 24 are geared via gear teeth 23 and 265 on the proximal end of the respective claw and configured to interoperate to perform a coordinated opening and closing action with master grapple arm 21 and servant grapple arm 24.

In an alternative embodiment, master grapple arm 21 and servant grapple arm 24 are replaced by equivalent, ungeared arms 21′ and 24′, not shown herein. Each of master grapple arm 21 and servant grapple arm is driven by an independent hydraulic cylinder. Such alternative embodiment has a further set of variations in that the master grapple arm 21 and servant grapple arm 24 can share a single pivot pin or be configured to have their own dedicated pin.

In a preferred embodiment, the hydraulic cylinder(s) of the present invention are supplied by a hydraulic line system having a hydraulic stop-lock to maintain hydraulic pressure in the hydraulic cylinder(s) during use.

Master grapple arm 21 and servant grapple arm 24 are generally tapered from their proximal ends to their distal ends and are curved such that they have an encircling configuration when they are activated to a closed or near closed position. Depending on the size of the log being grappled, the arms may totally nor partially enclose the circumference of the grappled log. The tips of the arms are preferably generally rounded to permit relative ease when the arm is translating beneath a log, such tip being less frictionally engaging the surface underneath the log. In the figures the tips are angled to provide a preferable interlocking configuration, but need not be.

Inner edges 28 are depicted as generally smooth surfaced. In preferred embodiments, there are provided tapered teeth on the inner edges of the claws. Such tapered teeth can generally be of a triangular shape. Such triangular shape may be formed by straight lines. Alternatively, the edge of the generally triangular shaped teeth may be inwardly curved, concaved. The degree of curvature may conveniently vary. In preferred embodiments, the degree of curvature configures the teeth and inner edge into a circular shape which can encircle a smaller log without the point of the teeth being injected into the log. However, when a larger log is grappled, the point of the teeth will be injected into the larger log. Accordingly, the teeth can be sized and shaped to enable flexibility in handling differently sized logs with or without injection of the point of the teeth into the log.

In operational use, the present grapple apparatus is used to engage an end of a downed tree or a cut log. Accordingly the grapple assembly is suspended, in a yieldable manner, generally transversely of a centerline of a tractor and the three point hitch components thereon. Positioning of the unloaded grapple assembly takes place by the action of the hydraulic cylinder with the grapple arms in an open position. The log is grappled by hydraulically closing the arms to a convenient position by actuating hydraulic cylinder. The grapple assembly is then elevated sufficient to enable dragging the engaged tree or log over the terrain.

An embodiment of the present invention is an apparatus for attachment to a tractor having a three point hitch system. The apparatus comprises a first frame having an upper portion and a lower portion attachable to the three points of hitch of the three point hitch system. In a preferred embodiment, the frame has a general “L” shape which lower leg extends away from the tractor or other vehicle which has the three point hitch system. The upper portion is rotatably connected to the three point hitch system and the lower portion is rotatably connected to said three point system so as to provide vertical translation to a third portion of said frame, which in the preferred embodiment is the extend leg of the “L” frame. The rotatable connection may be conveniently a pin and/or collar type system using known connections, such as “Y” yokes and stem and similar techniques.

A second frame is rotatably connected to the third portion of the first frame. The second frame can be a suitably shaped platform which contains thereon a grapple system. A first attachment means is affixed to the upper portion of the first frame and a second attachment means is affixed to the second frame. Attachment means can be any convenient well-known means, for example, simple extended plates having slots or rings to which other structures can be attached.

A connecting member is attached to the first and second attachment means. The connecting member is of a composition so that when the first frame is rotated to cause the second frame to elevate or lower, the connecting member provides rigid structure to prevent downward rotation of the second frame about the first frame when the grapple system is in a loading state, and the connecting member provides flexible structure to allow downward or upward rotation of the second frame about the first frame when grapple means is in a resting state. Non-limiting examples are chains and wire cables. The grapple system can comprise a first grapple arm, a second grapple arm and a force means to actuate the grapple arms to cooperatively grapple material.

The force means to actuate said grapple arms can conveniently be a hydraulic fluid system. Such hydraulic system can be connected to either or both first grapple arm and second grapple arm to cooperatively grapple material. When connected to only one of the two arms, the two arms can be geared together so that movement of one arm by the hydraulic force results in movement of the second arm.

The first grapple arm and/or second grapple arm can optionally comprise teeth to provide grapple force to hold said material. Such teeth can assist by frictionally engaging the surface of the grappled material or can inject into the material to provide holding force.

Additionally, the first grapple arm and/or second grapple arm can comprise a curvilinear surface to provide grapple force to hold said material. By sufficient curving of the inner, contacting edge of the arm, greater contact between the arm and the grappled material is obtained. One variation is to provide one or more teeth which can be curved themselves sufficiently to act as teeth on larger grappled material and can also act as a curvilinear edge on smaller grappled material. This conveniently extends the operational size of the grappled material.

Although various preferred embodiments of the invention have been described herein in detail, it will be understood by those skilled in the art that variations may be made thereto.

I claim:

1. An apparatus for attachment to a tractor having a three point hitch system, said apparatus comprising,
a first frame having an upper portion and a lower portion attachable to the three points of hitch of said three point hitch system, said upper portion being rotatably connected to three point hitch system and said lower portion being rotatably connected to said three point system so as to provide vertical translation to a third portion of said frame;
a second frame rotatably connected to said third portion of said first frame, said second frame comprising a grapple system;
a first attachment means affixed to said upper portion of said first frame;
a second attachment means affixed to said second frame;
a connecting member attached to said first and second attachment means, said connecting member being of a composition so that when said first frame is rotated to cause said second frame to elevate or lower, said connecting member provides rigid structure to prevent downward rotation of said second frame about said first frame when said grapple system is in a loading state, and said connecting member provides flexible structure to allow downward or upward rotation of said second frame about said first frame when grapple means is in a resting state; and
said grapple system comprising a first grapple arm, a second grapple arm and a force means to actuate said grapple arms to cooperatively grapple material.

2. The apparatus of claim 1 wherein said connecting member is a chain or a wire cable.

3. The apparatus of claim 1 wherein said force means to actuate said grapple arms is a hydraulic fluid system.

4. The apparatus of claim 1 wherein said force means acts only on said first grapple arm and said first grapple arm act on said second grapple arm to cooperatively grapple material.

5. The apparatus of claim 1 wherein said first grapple arm and/or second grapple arm comprise teeth to provide grapple force to hold said material.

6. The apparatus of claim 1 wherein said first grapple arm and/or second grapple arm comprise a curvilinear surface to provide grapple force to hold said material.
